(19) United States
(12) Patent Application Publication
(10) Pub. No.: US 2026/0210404 A1
(43) Pub. Date: Jul. 23, 2026

(54) SHIELD FOR A BEARING, BEARING AND METHOD OF ASSEMBLING A SHIELD IN A BEARING

(71) Applicant: Aktiebolaget SKF, Goteborg (SE)

(72) Inventors: Wei LI, Shanghai (CN); Xue YING, Kunshan (CN); Weihua XIA, Shanghai (CN); Hongyuan AN, Shanghai (CN)

(21) Appl. No.: 19/451,501

(22) Filed: Jan. 16, 2026

(30) Foreign Application Priority Data
Jan. 23, 2025 (CN) 202510108905.9

(51) Int. Cl. F16C 33/78

(52) U.S. Cl. CPC F16C 33/783; F16C 33/7833; F16C 33/785

(57) ABSTRACT

The present disclosure provides a shield for a bearing. The shield has a crimp structure extending from a body of the shield. The crimp structure includes a shoulder contact portion for contacting an outer surface of a shoulder of a bearing ring and a curled portion coupled to the shoulder contact portion. The curled portion has an end close to the shoulder contact portion. A cross-section of the curled portion has a curled shape. A bearing includes the shield and a method of assembling the shield into a bearing. The shield can be more firmly assembled in the bearing, and the shield will not loosen or fall off even in the event of vibration, impact, or thermal cycles occurring on the bearing. At the same time, the bearing can be provided with a larger internal space and the risk of radial deformation of the bearing can be reduced.

### CROSS-REFERENCE TO RELATED APPLICATION

This application claims priority to Chinese Patent Application No. 202510108905.9, filed January 23, 2025, the entirety of which is hereby incorporated by reference.

### FIELD

The present disclosure provides a shield for a bearing, a bearing, and a method of assembling the shield into the bearing.

### BACKGROUND

Bearings are widely used in various fields. A Bearing typically includes a shield disposed between the inner ring and the outer ring. Typically, the shield has an annular shape, with a crimped portion at its outer edge. Accordingly, the outer/inner rings of the bearing include an annular groove so that, ideally, the crimped portion undergoes some compression deformation and engages in the annular groove of the outer/inner rings during assembly of the shield, thereby holding the shield in place.

However, a problem faced by the prior art is that during use of the shield, the shield may loosen or even fall off because the bearing is affected by vibration, impact, thermal cycles and other working conditions. This has a very bad effect on the operation of the bearing.

Accordingly, there is a need in the art for a shield that can fit more firmly in a bearing without easily loosening or falling off.

### SUMMARY

In response to the above-mentioned problems and needs, the present disclosure proposes a new technical solution, which solves the above problems and brings other technical effects by adopting the following technical features.

The present disclosure provides a shield for a bearing, comprising: a crimp structure extending from a body of the shield and comprising: a shoulder contact portion for contacting an outer surface of a shoulder of a bearing ring; and a curled portion coupled to the shoulder contact portion; wherein the curled portion has an end close to the shoulder contact portion, a cross-section of the curled portion has a curled shape, and an included angle between a line L1 from a geometric center of the curled shape to the end and a ray L2 extending from the geometric center in a radial direction toward the shield body is greater than or equal to 20 degrees.

The present disclosure provides a bearing comprising: an inner ring and an outer ring; a shield as previously described fitted between the inner ring and the outer ring, and one or both of the inner ring and outer ring being the bearing ring.

The present disclosure provides a method of fitting a shield into a bearing, the shield being a shield as hereinbefore described, the method comprising: placing the shield between an inner ring and an outer ring of a bearing, wherein one or both of the inner ring and outer ring is the bearing ring; pressing the crimp structure of the shield by an assembly tool such that the side face of the end portion of the curled portion contacts the shoulder contact portion; further pressing the crimp structure of the shield by the assembly tool to engage the crimp structure into the annular groove of the bearing ring.

The present disclosure provides a shield, a bearing including the shield, and a method of assembling the shield into a bearing. Compared with the prior art, the shield of the present disclosure can be more firmly assembled in the bearing, and the shield will not loosen or fall off even in the event of vibration, impact, or thermal cycles occurring the bearing. At the same time, the bearing can be provided with a larger internal space and the risk of radial deformation of the bearing can be reduced.

### BRIEF DESCRIPTION OF DRAWINGS

FIG. 1 is a schematic diagram of a shield according to a preferable embodiment of the present disclosure;

FIG. 2 is a partial enlarged view of a shield according to a preferable embodiment of the present disclosure;

FIG. 3 is a schematic view and a partial enlarged view of a shield according to a preferable embodiment of the present disclosure after it has been assembled in a bearing;

FIG. 4 is a schematic view and a partial enlarged view showing the shield not yet assembled in the bearing according to the preferable embodiment of the present disclosure;

FIG. 5 is a schematic and enlarged view of a prior art shield and its assembly in a bearing.

### DETAILED DESCRIPTION

In order to make the purpose, technical solutions and advantages of the technical solutions of the present disclosure clearer, the technical solutions of the embodiments of the present disclosure will be clearly and completely described below with reference to the accompanying drawings of specific embodiments of the present disclosure. The same reference numbers in the drawings represent the same parts. It should be noted that the described embodiments are some, not all, of the embodiments of the present disclosure. Based on the described embodiments of the present disclosure, all other embodiments obtained by those of ordinary skill in the art without creative efforts fall within the scope of protection of the present disclosure.

Possible implementations within the scope of protection of the present disclosure may have fewer components than the embodiments illustrated in the figures, have other components not illustrated in the figures, different components, differently arranged components or differently connected components, etc. Furthermore, two or more components in the figures may be implemented within a single component, or a single component shown in the figures may be implemented as multiple separate components.

Unless otherwise defined, technical or scientific terms used herein shall have their ordinary meaning as understood by a person of ordinary skill in the art to which this disclosure belongs. The terms "first", "second" and similar words used in the specification and claims of this disclosure do not indicate any order, quantity or importance, but are only used to distinguish different components. When the number of components is not stated, the number of components can be one or more; likewise, words such as "a," "the," "said," and similar words do not necessarily indicate a quantitative limitation. Words such as "include" or "comprise" mean that the elements or items appearing before the word include the elements or items listed after the word and their equivalents, without excluding other elements or items. Words such as "installation", "setting", "connection" or "couple" are not limited to physical or mechanical installation, setting, and connection, but may include electrical installation, setting, and connection, whether direct or indirect. "Up", "down", "left", "right", etc. are only used to represent the relative orientation relationship when the device is used or the orientation relationship shown in the drawings. When the absolute position of the described object changes, the relative position Relationships may also change accordingly.

For ease of explanation, the direction of the rotational axis of a bearing is referred to herein as the axial direction, and the direction perpendicular to the axial direction is referred to as the radial direction. The term "inward" means towards the inside of the bearing, and conversely, the term "outer" means towards the outside of the bearing.

In view of the problem of a shield that tends to loosen and fall off, the inventor conducted deep research and found that the crimp structure of the prior art shield (as shown in the dotted frame in FIG. 5) is not designed reasonably, and hence, the shield cannot achieve an ideally assembled state, causing problems such as loosening and falling off.

Specifically, as shown in FIG. 5, during the assembly process of the shield of the prior art into a bearing, the end face 15a of the end of the crimp structure will first contact the shoulder contact portion 11a of the crimp structure, which will cause the crimp structure unable to be further deformed during the subsequent assembly process, thereby causing the crimp structure unable to be fully engaged with the annular groove 91 of the bearing shoulder (as shown in the enlarged view of FIG. 5), so that the shield and the annular groove 91 cannot be firmly fitted. In this case, when vibration, impact, or thermal cycles occur during the bearing operation, the shield will loosen or fall off.

In addition, it has been found that since the crimp structure does not fit well in the annular groove 91, it exerts a large radial force Fa on the edge portion of the annular groove 91 (as shown in the enlarged view of FIG. 5), which may cause deformation of the bearing shoulder, affect the stability of the outer diameter of the bearing, and may even affect the loading condition and life of the bearing.

Therefore, according to one aspect of the present disclosure, the present disclosure provides a shield for a bearing to solve the above problem.

According to another aspect of the present disclosure, the present disclosure also provides a bearing comprising the shield according to the present disclosure fitted between an inner ring and an outer ring of the bearing. It should be understood that both the inner ring and the outer ring of the bearing herein can be called as a bearing ring described herein after. Although in the preferable embodiments shown in the drawings the assembly between the outer bearing ring and the shield is described as an example, the concept of the present disclosure can also be applied to an inner ring of a bearing, i.e. the inner ring can be provided with an annular groove, and the inner edge of the shield can be accordingly provided with the crimp structure according to the present disclosure. In addition, both the inner and outer rings of the bearing may be provided with annular grooves, and both the inner and outer edges of the shield may be provided with the crimp structure according to the present disclosure. Thus, the “bearing ring” herein may be referred to one or both of the inner ring and the outer ring.

Referring specifically to the preferable embodiment of FIGS. 1-4, a shield in accordance with the present disclosure includes a crimp structure 1 extending from a shield body 2 and including: a shoulder contact portion 11 for contacting an outer surface 90 of a shoulder of a bearing ring (as shown in FIG. 4); and a curled portion 13 coupled to the shoulder contact portion 11. It should be understood that "coupled" here includes direct connection and indirect connection, that is, the curled portion 13 may be directly connected to the shoulder contact portion 11, or the curled portion 13 may be indirectly connected to the shoulder contact portion 11 through an intermediate portion. For example, the crimp structure 1 may further include a transition portion 12 extending from an end of the shoulder contact portion 11 away from the shoulder contact portion 11 and connecting the shoulder contact portion 11 with the curled portion 13.

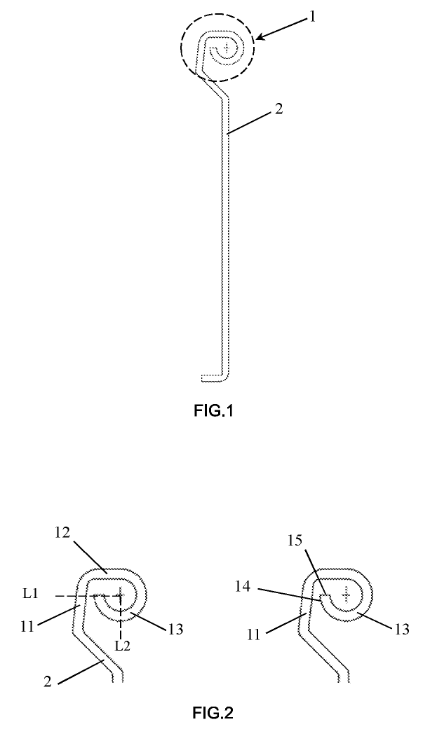

Further, the curled portion 13 has an end close to the shoulder contact portion 11, the cross-section of the curled portion 13 has a curled shape, and an included angle between a connecting line L1 from the geometric center of the curled shape to the end and a ray L2 extending from the geometric center toward the shield body 2 in the radial direction is greater than or equal to 20 degrees. More preferably, the included angle is greater than or equal to 60 degrees. In the preferable embodiment of FIG. 2, the included angle is 90 degrees.

It will be appreciated that the shield may have a various different configurations. For example, the shield body 2 may be generally annular and may include a flat portion and a ramp portion, with the crimp structure typically associated with the ramp portion, as in the embodiment of the drawings. A not shown shield may have a body that is flat circular and does not include a ramp portion, and the crimp structure is located on the edge of the flat body. The transition 12 may be a generally flat portion as shown, or may be a generally arcuate portion. The curled portion 13 may have a substantially round curled shape, or may have other curved shapes, or even a substantially multi-segmented polyline shape, as long as the included angle between the connecting line L1 from the geometric center of the curled shape to the end of the curled portion and the ray L2 extending from the geometric center toward the shield body in the radial direction satisfies the above relationship.

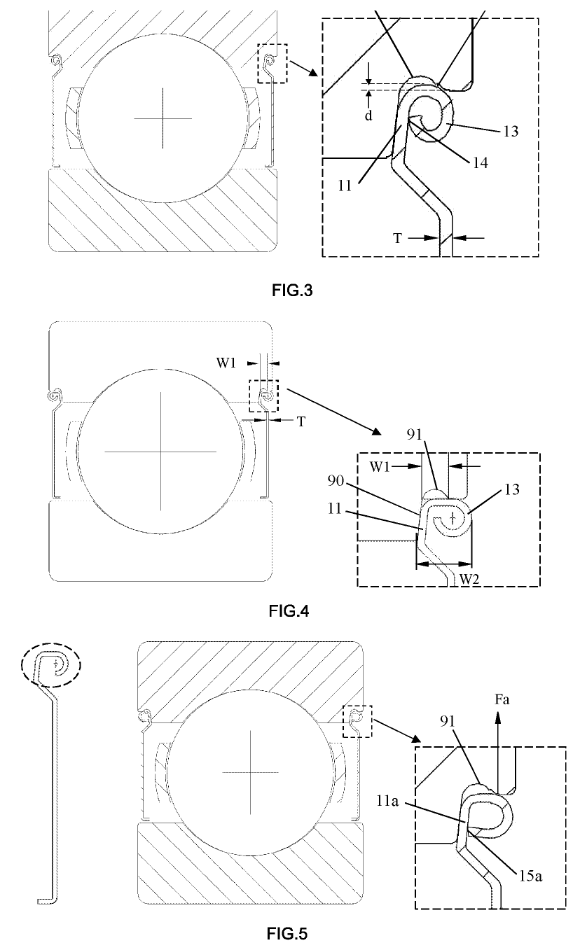

As mentioned above, in the prior art shown in FIG. 5, due to the poor design of the curled portion of the crimp structure, when the shield is assembled by an assembly tool, the end face 15a at the end of the curled portion will firstly abut the shoulder contact portion, causing the curled portion unable to be correctly extruded and deformed in the subsequent extrusion stage, thus causing the problem of poor assembly of the shield as mentioned above. In contrast, referring to FIG. 2, the present disclosure proposes to set the above-mentioned included angle so that when the assembly tool presses the crimp structure 1 during assembly of the shield, the side face 14 at the end of the curled portion 13 will move toward the shoulder contact portion 11, and after contacting the shoulder contact portion 11, the side face 14 will serve to guide the subsequent deformation of the entire curled portion 13; during subsequent pressing, the end face 15 will not impede deformation of the crimp structure, and the entire crimp structure 1 will generally "collapse" , so that there is a portion of the crimp structure 1 than can extend into the annular groove 91 of the shoulder of the bearing ring for engaging the crimp structure 1 (as shown in FIG. 3), thereby achieving a secure engagement of the shield.

In addition, the present disclosure not only achieves a stronger engagement between the crimp structure of the shield and the annular groove of the bearing ring, but in comparison with a case in which the crimp structure exerts a large radial force Fa on the shoulder of the bearing ring in the radial direction in the prior art shown in FIG. 5, the crimp structure 1 of the shield of the present disclosure, being deeper into the annular groove 91, exerts a force F tilting relative to the radial direction against the shoulder of the bearing ring as shown in FIG. 3, with the tilting force F being significantly less than the radial force Fa of the prior art and having a smaller component force in the radial direction, thereby reducing or even eliminating radial deformation of the bearing.

Further preferably, the end of the curled portion 13 has a side face 14 and an end face 15, the side face 14 faces the shoulder contact portion 11, and the end face 15 faces the transition portion 12. By this arrangement of the end of the curled portion, combined with the included angle arrangement as described above, it will facilitate the side face 14 of the curled portion 13 to firstly reach the shoulder contact portion 11, to play its guiding role during assembly of the shield.

Further preferably, the side face 14 may be an arc-shaped face, so that subsequent deformation of the curled portion 13 may be guided more smoothly. According to another preferable embodiment, the side face 14 may be a flat face.

In addition, according to different shield configurations, the shoulder contact portion 11 of the crimp structure 1 may be parallel or inclined with respect to the radial direction. In the preferable embodiment shown in the drawings, the shoulder contact portion 11 is inclined relative to the radial direction, and the inclination angle may be, for example, 0-8 degrees.

Further optimizations of the crimp structure 1 of the shield will now be described with reference to FIG. 4, which shows the shield positioned between the outer ring and the inner ring of the bearing but not yet assembled.

Specifically, the annular groove 91 of the shoulder of the bearing ring (the shoulder of the outer ring in FIG. 4) has an opening width W1. The crimp structure 1 has an axial width W2, and the axial width W2 is the maximum distance between the shoulder contact portion 11 and the top of the curled surface of the curled portion 13. Specifically, in the case where the shoulder contact portion is parallel to the radial direction (this case is not shown), the distance between the entire shoulder contact portion and the top of the curled surface of the curled portion is consistent, being W2; in the case where the shoulder contact portion 11 is inclined relative to the radial direction, the maximum distance is the distance between the lower end of the shoulder contact portion 11 and the top of the curled surface of the curled portion 13 shown in FIG. 4.

Furthermore, the ratio W1: W2 of the opening width W1 of the annular groove 91 to the axial width W2 of the crimp structure 1 is 0.35 to 0.65, and more preferably 0.4 to 0.6. By setting this width relationship, it can better ensure that the crimp structure can reach a state of deep engagement into the annular groove 91 after being pressed and deformed by the assembly tool, to achieve the post-assembly state shown in FIG. 3.

In the preferable embodiment shown in FIG. 4, the shield has the same thickness as a whole. Further preferably, referring to FIG. 3, the crimp structure 1 has a thickness T (which is also the thickness T of the entire shield), and the ratio T: W1 of the thickness T to the opening width W1 of the annular groove 91 is 0.2 to 0.45, more preferably is 0.25 to 0.35. Of course, it should be understood that there are cases where the thickness of each part of the shield is not uniform (this case is not shown), in which case the above relationship is also satisfied between the thickness of the crimp structure and the opening width of the annular groove.

Through this arrangement, further structural optimization between the crimp structure and the annular groove can be achieved, which is more conducive to achieving the assembly between the crimp structure and the annular groove. Furthermore, it has been found that when the shield is manufactured according to such a proportional relationship, the thickness of the shield can be reduced, providing more internal space for the bearing and also reducing the risk of grease leakage, when the shield is manufactured according to the same thickness.

As previously mentioned, the present disclosure also provides a bearing including a shield as previously described fitted between the inner and outer rings of the bearing.

One way in the art to judge the firmness of the shield assembly is to test how much force is required to remove the shield from the bearing. Many tests have shown that when the mating relationship between the crimp structure 1 and the annular groove 91 is achieved after the shield is assembled with the bearing, the force required to remove the shield of the present disclosure can be increased by 2 to 4 times compared to the prior art shown in FIG. 5.

Further preferably, in a bearing equipped with the shield according to the present disclosure, the crimp structure 1 has a portion that engages into the annular groove 91 of the ferrule, as shown in FIG. 3. The depth d of this portion entering into the annular groove 91 from the opening edge of the annular groove 91 is at least half of the thickness T of the crimp structure 1, thereby further enhancing the joint strength between the crimp structure 1 and the annular groove 91.

Further preferably, as shown in FIG. 3, the side face 14 of the end portion of the curled portion 13 can abut against the shoulder contact portion 11. In some embodiments not shown, the end portion of the curled portion 13 may be separated from the shoulder contact portion 11 after being deformed by contact with the shoulder contact portion 11. In other words, the end portion of the curled portion 13 will be tilted again after being deformed by contact with the shoulder contact portion 11. When this situation occurs, it also indicates that the crimp structure 1 has undergone sufficient deformation and has sufficiently fitted into the annular channel 91.

According to yet another aspect of the present disclosure, the present disclosure also proposes a method of assembling a shield into a bearing, the shield being a shield as described above, the method comprising:

placing the shield between the inner ring and the outer ring of the bearing (the state shown in FIG. 4). One or both of the inner ring and the outer ring is the aforementioned bearing rings. pressing the crimp structure 1 of the shield by an assembly tool so that the side face 14 of the end portion of the curled portion 13 contacts the shoulder contact portion 11;

further pressing the crimp structure 1 of the shield by the assembly tool to engage the crimp structure 1 into the annular groove 91 of the bearing ring (the state shown in FIG. 3).

In summary, the present disclosure provides a shield, a bearing including the shield, and a method of assembling the shield into the bearing. Compared with the prior art, the shield of the present disclosure can be more firmly assembled in the bearing, and the shield will not loosen or fall off even in the event of vibration, impact, or thermal cycles occurring to the bearing. At the same time, the bearing can be provided with a larger internal space and the risk of radial deformation of the bearing can be reduced.

The exemplary embodiments of the present disclosure have been described in detail above with reference to preferable embodiments. However, those skilled in the art will understand that various modifications and modifications can be made to the above specific embodiments without departing from the concept of the present disclosure. Modifications, and various technical features and structures proposed in the present disclosure can be made in various combinations without exceeding the scope of protection of the present disclosure, which is determined by the appended claims.

What is claimed is:

1. A shield for a bearing comprising:
a crimp structure extending from a body of the shield and comprising:
a shoulder contact portion for contacting an outer surface of a shoulder of a bearing ring; and
a curled portion coupled to the shoulder contact portion;
wherein the curled portion has an end close to the shoulder contact portion, a cross-section of the curled portion has a curled shape, and an included angle between a line from a geometric center of the curled shape to the end and a ray extending from the geometric center in a radial direction toward the shield body is greater than or equal to 20 degrees.

2. The shield according to claim 1, wherein the included angle is greater than or equal to 60 degrees.

3. The shield according to claim 1, wherein the crimp structure further comprises a transition portion extending from the end of the shoulder contact portion away from the shoulder contact portion and connecting the shoulder contact portion with the curled portion;
wherein the end of the curled portion has a side face and an end face, the side face facing the shoulder contact portion and the end face facing the transition portion.

4. The shield according to claim 3, wherein the side face is a curved face or a flat face.

5. The shield according to claim 1, wherein:
the shoulder of the bearing ring has an annular groove for engaging the crimp structure, and the annular groove has an opening width;
the crimp structure has an axial width, and the axial width is the maximum distance between the shoulder contact portion and the top of the curled surface of the curled portion;
wherein the ratio of the opening width to the axial width is 0.35 to 0.65.

6. The shield according to claim 5, wherein the ratio of the opening width to the axial width is 0.4 to 0.6.

7. The shield according to claim 1, wherein:
the bearing ring shoulder has an annular groove for engaging the crimp structure, and the annular groove has an opening width;
the crimp structure has a thickness, and the ratio of the thickness to the opening width is 0.2 to 0.45.

8. The shield according to claim 7, wherein the ratio of the thickness to the opening width is 0.25 to 0.35.

9. A bearing comprising:
an inner ring and an outer ring;
the shield according to claim 1 fitted between the inner ring and the outer ring, and one or both of the inner ring and outer ring being the bearing ring.

10. The bearing according to claim 9, wherein the crimp structure has a portion which engages in the annular groove of the bearing ring, and the depth of the portion entering into the annular groove from an opening edge of the annular groove is at least half of the thickness of the crimp structure.

11. The bearing according to claim 9, wherein:
a side face of an end portion of the curled portion abuts against the shoulder contact portion; or
the end portion of the curled portion is separated from the shoulder contact portion after being deformed by contact with the shoulder contact portion.

12. A method of fitting the shield of claim 1 into a bearing, the method comprising:
placing the shield between an inner ring and an outer ring of a bearing, wherein one or both of the inner ring and outer ring is the bearing ring;
pressing the crimp structure of the shield by an assembly tool such that the side face of the end portion of the curled portion contacts the shoulder contact portion; and
further pressing the crimp structure of the shield by the assembly tool to engage the crimp structure into the annular groove of the bearing ring.
